(19) United States
(12) Patent Application Publication
(10) Pub. No.: US 2012/0068559 A1
(43) Pub. Date: Mar. 22, 2012

(54) ROTATING SHAFT SUPPORT APPARATUS AND MAGNETIC MOTOR HAVING THE SAME

(75) Inventors: Yuki NAKAMURA, Kariya-city (JP); Kunihito Ando, Okazaki-city (JP); Nobuhiko Yoshioka, Anjo-city (JP); Takahiro Naganuma, Kariya-city (JP); Tomoaki Kawabata, Takahama-city (JP)

(73) Assignees: DENSO CORPORATION, Kariya-city (JP); ADVICS CO., LTD., Kariya-city (JP)

(21) Appl. No.: 13/234,717

(22) Filed: Sep. 16, 2011

(30) Foreign Application Priority Data
Sep. 20, 2010 (JP) 2010-210300

(51) Int. Cl. H02K 37/24; F16C 19/00

(52) U.S. Cl. 310/48; 464/178

(57) ABSTRACT

A apparatus is provided in which, in a state before being assembled to a drive target, one end of a rotating shaft is not supported by a bearing, and in this state, the rotating shaft is pressed to the side of a bracket by coil springs and thus centering of the rotating shaft is maintained. In this way, axial run-out of the rotating shaft before a magnetic motor is assembled to the drive target is inhibited. Thus, damage and deterioration in assembly efficiency as a result of axial run-out of the rotating shaft can be inhibited, such as deterioration in assembly efficiency caused by adhesion between a magnet and coils wound on an armature core, for example.

### TECHNICAL FIELD

The present invention relates to a rotating shaft support apparatus and a magnetic motor having the same.

### BACKGROUND ART

In related art, an unlubricated vacuum pump that is driven by a motor is disclosed in PTL 1. This unlubricated vacuum pump is supported by a total of four bearings, namely, by two separate bearings of a rotating shaft provided on the motor and of a rotating shaft provided on a pump portion, respectively. In this structure, the pump is motor driven by coupling the leading ends of each of the rotating shafts to each other.

### CITATION LIST

### Patent Literature

### PTL 1

Japanese Patent Application Publication No. JP-A-7-217567

### SUMMARY OF INVENTION

### Technical Problem

However, when the pump is supported by the two separate bearings on each of the two rotating shafts, respectively, it is difficult to align centers of the shafts when coupling the two rotating shafts to each other. In order to avoid this, a structure is conceivable in which, for example, with respect to one of the rotating shafts, the bearing that supports the leading end on the coupling side is omitted, and support of the rotating shaft on the side on which the bearing has been omitted is performed by the coupling with the other rotating shaft, or by being fitted into the bearing that supports the leading end on the coupling side of the other rotating shaft. However, in a state before coupling, axial run-out occurs in the rotating shaft on the side on which the bearing is omitted, and it is possible that the axial run-out may result in damage to the rotating shaft, cause damage to parts etc. in proximity to the rotating shaft, or may lead to deterioration in assembly efficiency. For example, in the case of a rotating shaft of a magnetic motor, there is a risk that adhesion may occur between a magnet and a coil as a result of the axial run-out and that assembly efficiency may thus deteriorate.

In light of the foregoing, it is an object of the present invention to provide a rotating shaft support apparatus and a magnetic motor having the same that are capable of inhibiting damage and deterioration in assembly efficiency as a result of axial run-out when one end of a rotating shaft is not supported by a bearing.

### SOLUTION TO PROBLEM

In order to achieve the above-described object, according to a first aspect of the present invention, when one end of a rotating shaft is not coupled to another rotating body, shaft rotation of the rotating shaft is suppressed by part of the rotating shaft being caused to come into contact with a housing by a spring. At the same time, when the one end of the rotating shaft is coupled to the other rotating body, the one end of the rotating shaft is caused to separate from the housing in resistance to the biasing force of the spring.

In this way, even when the one end of the rotating shaft is not coupled to the other rotating body, the axial run-out of the rotating shaft can be suppressed by the one end of the rotating shaft being caused to come into contact with the housing by the spring. In this way, when the one end of the rotating shaft is not supported by the bearing, a rotating shaft support construction is possible that can inhibit damage and deterioration in assembly efficiency as a result of axial run-out of the rotating shaft. Then, it is possible to couple the rotating shaft and the rotating body by a simple operation of causing the rotating shaft and the rotating body to come into contact etc. and moving them in the axial direction, and at the same time, it is possible to enable the rotating shaft and the rotating body to rotate together. Note that, “one end” here refers to a portion that, on the rotating shaft, is closer to a coupling location with the rotating body than another end that is supported by a first bearing.

According to a second aspect of the present invention, a rotating shaft side contact portion that comes into contact with the housing is provided on the one end of the rotating shaft and a housing side contact portion that comes into contact with the rotating shaft side contact portion is provided on the housing. A tapered surface, a diameter of which becomes smaller toward the side of an biasing direction of the spring, is formed on at least one of the contact portions. Thus, the axial run-out of the rotating shaft is suppressed by both the contact portions coming into contact with the tapered surface.

In this way, by making the tapered surface a location of contact between the rotating shaft and the housing, contact positioning between the rotating shaft and the housing can be easily performed, and it is possible to maintain centering of the rotating shaft.

According to a third aspect of the present invention, the other rotating body is rotatably supported by a different housing than the housing, and the one end of the rotating shaft is axially supported by being coupled to the other rotating body when both the housings are fixed.

In this way, the rotating shaft can easily be axially supported by an assembly operation when fixing both the housings.

According to a fourth aspect of the present invention, the one end of the rotating shaft is rotatably supported by being inserted through a second bearing that is provided in the different housing and that rotatably supports the other rotating body.

In this way, by inserting the one end of the rotating shaft through the second bearing that rotatably supports the other rotating body and thus axially supporting the rotating shaft, both the rotating shaft and the other rotating body are rotatably supported by the same bearing. For that reason, axial alignment of both the rotating shaft and the other rotating body can be easily performed.

According to a fifth aspect of the present invention, the rotating shaft and the other rotating body are directly coupled inside the second bearing such that rotation transmission is possible.

In this way, by directly coupling the rotating shaft and the other rotating body such that rotation transmission is possible, the rotating shaft and the other rotating body can be coupled by a simple structure, and another relay member in order to perform rotation transmission between the rotating shaft and the other rotating body is not necessary. For that reason, it is possible to reduce a size in the axial direction of a device to which the rotating shaft support apparatus is applied.

The rotating shaft support apparatus according to the first to fifth aspects of the present invention, is applied, for example, to a magnetic motor, such as in a sixth aspect of the present invention. According to the sixth aspect of the present invention, the magnetic motor includes an armature core that is arranged such that it encompasses the rotating shaft, a stator, which is arranged around the periphery of the armature core, is provided on the housing, and one of the armature core and the stator is formed of a permanent magnet.

Note that the reference numbers in brackets for each of the above-described units are intended to show the relationship with the specific units described in the following embodiments.

### BRIEF DESCRIPTION OF DRAWINGS

FIG. 1 is a partial cross section of a magnetic motor that adopts a rotating shaft support construction according to a first embodiment of the present invention and a drive target that is driven by the magnetic motor;

FIG. 2 is an enlarged cross section of the magnetic motor before it is assembled to the drive target;

FIG. 3A is a cross section showing a state in the proximity of the coupling side portion of a rotating shaft of the magnetic motor before the magnetic motor is assembled to the drive target; and

FIG. 3B is a cross section showing a state in the proximity of the coupling side portion of the rotating shaft of the magnetic motor after the magnetic motor is assembled to the drive target.

### DESCRIPTION OF EMBODIMENTS

Hereinafter, embodiments of the present invention will be explained based on the drawings. Note that portions that are the same or equivalent to each other in each of the embodiments that are hereinafter described are assigned the same reference numerals in the drawings.

### First Embodiment

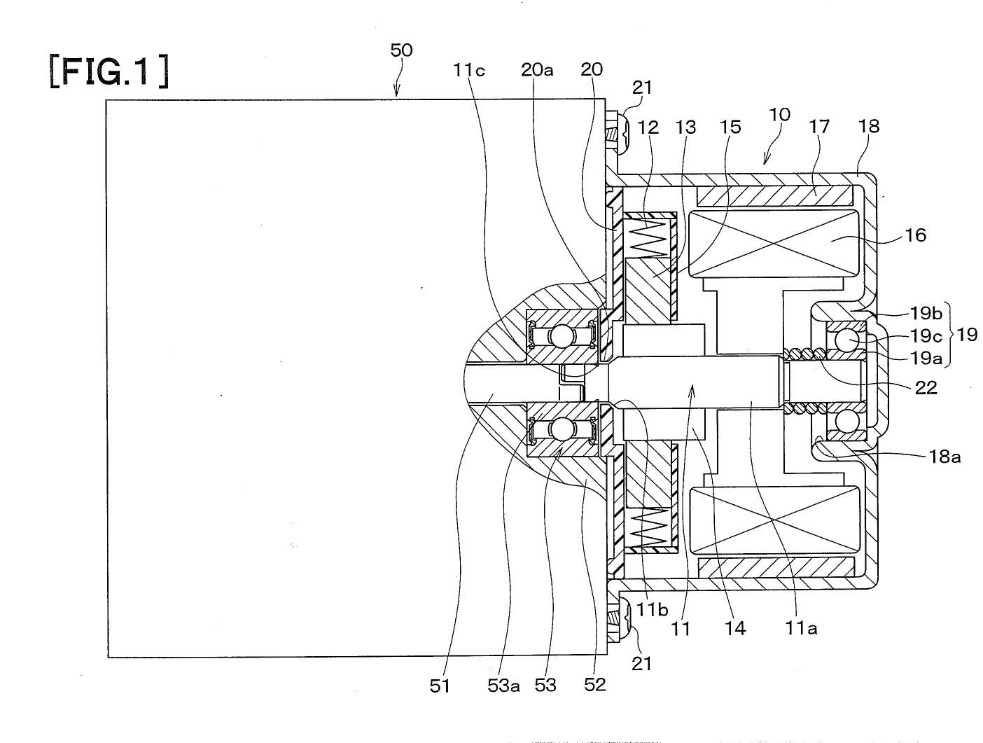

FIG. 1 is a partial cross section of a magnetic motor 10 that adopts a rotating shaft support construction according to an embodiment of the present invention and a drive target 50 that is driven by the magnetic motor 10. Hereinafter, the shaft support construction according to the present embodiment and the magnetic motor 10 to which the rotating shaft support construction is applied will be explained with reference to FIG. 1.

As shown in FIG. 1, the magnetic motor 10 is fixed to the drive target 50, and a rotating shaft 11 of the magnetic motor 10 is coupled to a drive shaft 51 that corresponds to a rotating body provided on the drive target 50. A rotary pump device that is used to suck and discharge brake fluid and that is provided in an actuator for the control of brake fluid pressure is an example of the drive target 50, for example. By driving the drive shaft 51, a rotary pump, such as a trochoid pump, that is provided inside the rotary pump device is driven, and brake fluid pressure control is performed by performing suction and discharge of the brake fluid. The rotating shaft 11 and the drive shaft 51 are coupled inside a bearing 53 that is fixed inside a casing (housing) 52 of the drive target 50.

Note that, in the present embodiment, an example of a coupling structure is given in which a leading end of the rotating shaft 11 and a leading end of the drive shaft 51 on the side on which they are coupled have a half cylinder shape, and the leading end portions are mutually displaced by 180 degrees and thus coupled together. However, another coupling structure may be used.

The magnetic motor 10 is driven based on a power supply from a power source that is not shown in the drawings, and on the power source side, and leading ends of each of brushes 13 that cause continuity between the power source and a commutator 14 are pushed into contact with the commutator 14 by springs 12.

Specifically, the commutator 14 has a cylindrical shape and at the same time has a structure such that it is divided into a plurality of uniform intervals in the circumferential direction. Each divided section is caused to come into contact sequentially with each of the brushes 13 in accordance with rotation. Each of the brushes 13 is held by brush holders 15 that are arranged at uniform intervals in the circumferential direction centering around the commutator 14. Then, when the leading ends of each of the brushes 13 are caused to come into contact with the commutator 14 and the commutator 14 is caused to rotate, the commutator 14 is caused to come into contact sequentially with each of the brushes 13 that are arranged in the circumferential direction of the commutator 14. Note that the above-mentioned springs 12 constantly bias the brushes 13 towards the side of the commutator 14 inside the brush holders 15, thus causing the brushes 13 to constantly come into contact with the commutator 14.

The commutator 14 is integrated with the rotating shaft 11 that is arranged on the same axis as the commutator 14, and with an armature core 16 that is arranged on the same axis as the commutator 14 around an outer periphery of the rotating shaft 11. The armature core 16 is structured such that a plurality of coils are wound around the circumferential direction of the rotating shaft 11 at uniform intervals, taking the axial direction of the rotating shaft 11 as the longitudinal direction.

In addition, a magnet 17 is arranged around an outer periphery of the armature core 16, and is separated from the armature core 16 by a specific distance. At the same time, a motor case 18 is provided to which the armature core 16 is fixed. The motor case 18 has a cylindrical shape with a closed bottom end, and a bearing 19 is arranged in a central portion of the motor case 18. The rotating shaft 11 is axially supported by fitting another end, which is opposite to the end coupled to the drive shaft 51, into the bearing 19. More specifically, the bearing 19 has a structure that includes an inner ring 19a, an outer ring 19b and a rolling element 19c. The rear end of the rotating shaft 11 is fitted into a hole of the inner ring 19a and thus the rotating shaft 11 is axially supported. Then, the bearing 19 is mounted on the motor case 18 by inserting the outer ring 19b into a recessed portion 18a that is formed on the bottom surface of the motor case 18 by a bending process or the like.

Meanwhile, a bracket 20 is arranged on an open portion side of the motor case 18, namely on the side opposite to the bottom portion on which the bearing 19 is provided, the bracket 20 forming a lid member of the motor case 18. The motor case 18 and the bracket 20 form a housing that houses each portion forming the motor 10. Note that, in the present embodiment, the brush holders 15 are formed integrally in plastic as part of the bracket 20.

A center hole 20a is formed in the bracket 20, and the one end of the rotating shaft 11 is inserted through the center hole 20a. The inner diameter of the center hole 20a is larger than the outer diameter of a portion of the rotating shaft 11 that is inserted through the center hole 20a, and a specific clearance is provided between the center hole 20a and the rotating shaft 11. Further, the inner diameter of the center hole 20a is smaller than the outer diameter of a portion of the rotating shaft 11 that has a maximum diameter (a large diameter portion 11a that will be described later). In a state in which the open portion side of the motor case 18 is covered by the bracket 20, the magnetic motor 10 is assembled to the drive target 50 by fastening the open end of the motor case 18 to the casing 52 of the drive target 50 using screws 21 or the like.

The basic structure of the magnetic motor 10 is formed in this manner. In the present embodiment, the magnetic motor 10 adopts the rotating shaft support apparatus that can suppress axial run-out of the rotating shaft 11.

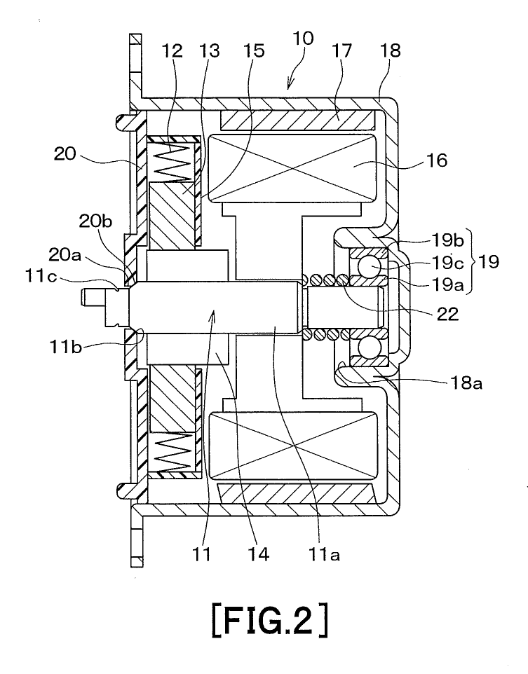

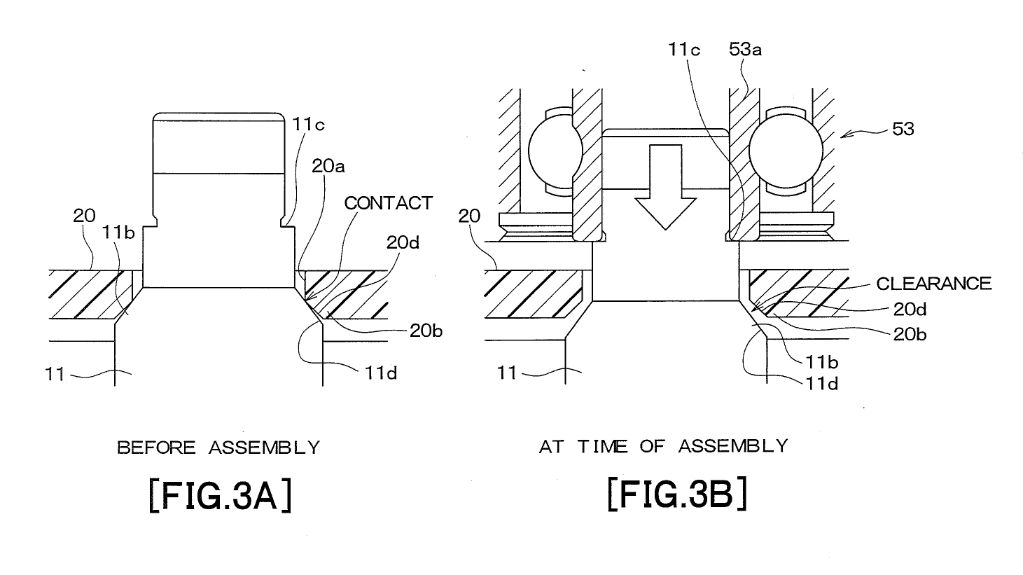

FIG. 2 shows an enlarged cross section of the magnetic motor 10 before being assembled to the drive target 50. FIG. 3A and FIG. 3C show cross section diagrams indicating a state in the proximity of the coupling side end portion of the rotating shaft 11 of the magnetic motor 10 before being assembled to the drive target 50 and when assembled to the drive target 50. The rotating shaft support apparatus of the present embodiment will be explained with reference to these figures.

As shown in FIG. 2, the large diameter portion 11a, whose outer diameter is larger than the inner diameter of the center hole 20a of the bracket 20, is provided on the rotating shaft 11, between the end portion on the side that is fitted into the bearing 19 and the end portion on the side that is coupled to the drive shaft 51 of the drive target 50. The leading end of the large diameter portion 11a has a stepped shape, and is a rotating shaft side contact portion 11b that is caused to come into contact with the bracket 20. The rotating shaft side contact portion 11b is formed of a tapered surface 11d that tapers, and the outer diameter of the large diameter portion 11a is the maximum diameter of the tapered surface 11d. In addition, a stepped portion 11c is formed further to the side of the leading end of the rotating shaft 11 than the large diameter portion 11a. The outer diameter of the stepped portion 11c is larger than the inner diameter of an inner ring 53a of the bearing 53.

In addition, a coil spring 22 is provided with respect to the large diameter portion 11a, between the end portion on the same side as the bearing 19 and the bearing 19. The coil spring 22 functions as an spring, and bias the rotating shaft 11 in the axial direction (to the bracket 20 side). In other words, the coil spring 22 is contracted between the large diameter portion 11a and an inner ring 19a of the bearing 19, and the restoring force of the coil spring 22 biases the large diameter portion 11a towards the bracket 20 side. As a result, when in a state before the magnetic motor 10 is assembled to the drive target 50, the rotating shaft side contact portion 11b of the rotating shaft 11 comes into contact with the bracket 20 and is pressed against the open end of the center hole 20a, as shown in FIG. 3A.

Then, when the rotating shaft 11 is assembled to the drive target, 50, at the same time that the rotating shaft 11 is coupled to the drive shaft 51 on the side of the drive target 50, the stepped portion 11c that is positioned further to the leading end of the rotating shaft 11 than the large diameter portion 11a is pushed by the end portion of the inner ring 53a of the bearing 53, and thus the rotating shaft 11 is pushed to the bottom side of the motor case 18. In this way, as shown in FIG. 3B, the rotating shaft 11 that resists the elastic force (the biasing force) of the coil spring 22 is moved in the direction of the arrows shown in the drawing, and thus the contact between the large diameter portion 11a, which is pushed against the open end of the center hole 20a of the bracket 20, and the bracket 20 is released, and a state is obtained in which the large diameter portion 11a and the bracket 20 are separated by a specific distance.

Here, as shown in FIG. 3A and FIG. 3B, the portion of the center hole 20a of the bracket 20 that comes into contact with the large diameter portion 11a is a housing side contact portion 20b. The tapered surface 11d and a tapered surface 20d are formed on at least one of the housing side contact portion 20b and the rotating shaft side contact portion 11b of the rotating shaft 11, the diameter of the tapered surfaces 11d and 20d becoming smaller in the direction of the biasing force of the coil spring 22. In the present embodiment, the tapered surfaces 11d and 20d are provided on both the contact portions 11b and 20b. By providing this type of tapered surface 11d and 20d, before the magnetic motor 10 is assembled to the drive target 50, when the rotating shaft side contact portion 1 lb is pressed against the housing side contact portion 20b of the center hole 20a of the bracket 20, at least one of the contact portions 11b and 20b comes into contact with the opposing tapered surfaces 11d and 20d.

Then, by pressing the rotating shaft side contact portion 11b of the rotating shaft 11 (this may be the tapered surface 11d, or may be another portion of the contact portion 11b apart from the tapered surface 11d) against the tapered surface 20d of the bracket 20, or by pressing the tapered surface 11d of the rotating shaft 11 against the housing side contact portion 20b of the bracket 20 (this may be the tapered surface 20d or may be another portion of the contact portion 20b apart from the tapered surface 20d), contact position matching of these members can be easily performed, and it is possible to maintain centering of the rotating shaft 11.

For example, in the case of the present embodiment, as shown in FIG. 3, the tapered surface 11d of the rotating shaft 11 is pressed against a portion (a corner portion) other than the tapered surface 20d of the housing side contact portion 20b of the bracket 20. By pressing in this manner, the housing side contact portion 20b comes into contact with the entire periphery of the tapered surface 11d. Then, as the tapered surface 11d has a truncated cone shape centering on a center line of the rotating shaft 11, the center line of the rotating shaft 11 matches a center line of the center hole 20a and centering of the rotating shaft 11 is maintained.

Furthermore, of the rotating shaft side contact portion 11b of the rotating shaft 11, even if portions apart from the tapered surface 11d are pressed against the tapered surface 20d of the bracket 20, in a similar manner to that described above, a state is reached in which the rotating shaft side contact portion 11b comes into contact with the entire periphery of the tapered surface 20d. Then, as the inner peripheral surface of the tapered surface 20d has a truncated cone shape centering on the center line of the center hole 20a, the center line of the rotating shaft 11 and the center line of the center hole 20a are matched and centering of the rotating shaft 11 is maintained.

As centering of the rotating shaft 11 can be maintained in this way, axial run-out of the rotating shaft 11 can be suppressed before the magnetic motor 10 is assembled to the drive target 50.

With the above-described structure, the magnetic motor 10 is structured such that it is provided with the rotating shaft support apparatus according to the present embodiment. In this type of the magnetic motor 10, in a state before being assembled to the drive target 50, the structure is such that one end of the rotating shaft 11 is not supported by a bearing, but in this state, the rotating shaft 11 is pressed to the bracket 20 side by the coil spring 22, and it is thus possible to maintain centering of the rotating shaft 11.

For that reason, the axial run-out of the rotating shaft 11 is suppressed before the magnetic motor 10 is assembled to the drive target 50. It is thus possible to inhibit damage or deterioration in assembly efficiency as a result of axial run-out of the rotating shaft 11, such as, for example, adhesion between the magnet 17 and coils wound on the armature core 16 that results in a deterioration in assembly efficiency. In this way, when the one end of the rotating shaft 11 is not supported by the bearing, the rotating shaft support apparatus is possible by which damage and deterioration in assembly efficiency caused by axial run-out of the rotating shaft 11 can be inhibited. Also, at the same time as being possible to couple the rotating shaft 11 and the drive shaft 51 by a simple operation in which the rotating shaft 11 is caused to move in the axial direction by coming into contact with the drive shaft 51 or the like, it is possible to enable the rotating shaft 11 and the drive shaft 51 to rotate in concert with each other.

Furthermore, by axially supporting the rotating shaft 11 by inserting one end of the rotating shaft 11 inside the bearing 53 that axially supports the drive shaft 51, the rotating shaft 11 and the drive shaft 51 are axially supported by the same bearing. As a result, axial alignment of both the shafts is easily performed.

Note that motor performance measurements are performed before shipment of the magnetic motor 10, and in the motor performance measurements also, the motor performance can be easily measured by pushing the rotating shaft 11 to the bottom side of the motor case 18 and thus releasing the contact between the large diameter portion 11a and the bracket 20.

### Other Embodiments

In the above-described embodiment, a coupling structure is adopted in which both the leading ends of the rotating shaft 11 and the drive shaft 51 are coupled inside the bearing 53 provided in the drive target 50, and the rotation of the rotating shaft 11 is transmitted to the drive shaft 51 via this coupling structure. However, this is merely one example of a rotational transmission structure and another mode may be adopted. In other words, rather than directly coupling the leading end of the rotating shaft 11 and the leading end of the drive shaft 51, the leading end of the rotating shaft 11 and the leading end of the drive shaft 51 may be indirectly coupled via the inner ring 53a of the bearing 53 and the rotational transmission from the rotating shaft 11 to the drive shaft 51 may be performed via the inner ring of the bearing 53.

It should be noted that by coupling the rotating shaft 11 and the drive shaft 51 such that direct rotational transmission is possible, the rotating shaft 11 and the drive shaft 51 can be coupled by a simple structure, and it is possible to perform the rotational transmission between the rotating shaft 11 and the drive shaft 51 without need for another relay member. As a result, an effect is obtained by which it is possible to make smaller in the axial direction the device to which the rotational shaft support apparatus is applied.

Furthermore, in the above-described embodiment, the stepped portion 11c is formed on the leading end on the coupling side of the rotating shaft 11, and a structure is adopted in which the rotating shaft 11 is pressed to the bottom of the motor case 18 by the stepped portion 11c being pressed by the inner ring 53a of the bearing 53. However, by the drive shaft 51 being directly coupled to the rotating shaft 11, the rotating shaft 11 may be directly pressed to the bottom of the motor case 18 by the drive shaft 51.

Further, in the above-described embodiment, of the bracket 20, a peripheral wall portion that forms the center hole 20a is the contact portion that is caused to come into contact with the tapered surface 11d of the rotating shaft 11, and the center hole 20a has a circular shape. However, the center hole 20a need not necessarily have a circular shape, and may be, for example, a regular polygon. Even with this type of shape, by forming the tapered surface 11d on the rotating shaft side contact portion 11b of the rotating shaft 11, for example, centering of the rotating shaft 11 can be easily maintained. Furthermore, even if the center hole 20a is the regular polygon in this manner, if the portion that comes into contact with the rotating shaft side contact portion 11b of the rotating shaft 11 is the tapered portion 20d, centering of the rotating shaft 11 can be easily maintained.

In the above-described embodiment, the axial run-out of the rotating shaft 11 is suppressed by causing a portion (a corner portion) that is different from the tapered surface 20d of the housing side contact portion 20b to come into contact with the tapered surface 11d of the rotating shaft side contact portion 11b. However, as described above, a structure may be adopted in which the tapered surface 20d of the housing side contact portion 20b is caused to come into contact with the rotating shaft side contact portion 11b, and the axial run-out of the rotating shaft 11 may be suppressed in this manner. In this case, a structure may be adopted in which the tapered surface 11d of the rotating shaft side contact portion 11b is caused to come into contact with the tapered surface 20d of the housing side contact portion 20b, or a structure may be adopted in which a portion other than the tapered surface 11d is caused to come into contact with the tapered surface 20d. Alternatively, the tapered surface (11d or 20d) may be provided on only one of the contact portions 11b and 20b, and the other portion may be caused to come into contact with the tapered portion. Note that, in the present invention, it is not necessary to provide the tapered surface (11d and 20d) on each of the contact portions 11b and 20b. Thus, the tapered surface on each of the contact portions 11b and 20b may be omitted and a stepped portion (a portion with a different diameter) may simply be provided. In this case, the axial run-out of the rotating shaft 11 is suppressed by a large diameter portion of the stepped portion coming into contact with the housing.

In the above-described embodiment, the biasing direction of the coil spring 22 is toward the side of the one end of the rotating shaft 11 (the drive shaft 51 side), but is not limited to this example. For example, a spring may be provided that biases the rotating shaft in the opposite direction, namely toward the side of the other end, and the axial run-out of the rotating shaft may be suppressed by the rotating shaft being caused to come into contact with the housing by that biasing force. In this case, a structure is used such that, in a state in which the rotating shaft has been slid to the side of the one end by the coupling of the rotating shaft and the rotating body (a state in which the rotating shaft side contact portion and the housing side contact portion are separated), the state of coupling of both the rotating shaft and the rotating body is maintained. For example, a structure is used in which the rotating shaft and the rotating body (or another coupling member for which rotation transmission with both the rotating shaft and the rotating body is possible) are engaged with each other.

Note that in the present invention, an armature core that is formed of a permanent magnet may be adopted for the magnetic motor. Further, in the above-described embodiment, the explanation gives the magnetic motor 10 as an example of a motor, but the rotating shaft support apparatus of the present invention may be applied to another form of motor or another device that has a rotating shaft. In addition, in the above explanation, a rotary pump device is given as an example of the drive target 50, and the drive shaft 51 is given as an example of the rotating body, but the drive target 50 may be a device other than the rotary pump device.

1. A rotating shaft support apparatus comprising:
a rotating shaft, of which one end is for being coupled to another rotating body;
a housing in which the rotating shaft is housed, the housing being provided with a hole through which the one end of the rotating shaft is inserted and;
a first bearing that is arranged inside the housing and that rotatably supports another end of the rotating shaft; and
a spring that biases the rotating shaft in an axial direction, the rotating shaft being rotatably supported by the first bearing;
wherein
when the one end of the rotating shaft is not coupled to the other rotating body, axial run-out of the rotating shaft is suppressed by the one end of the rotating shaft being caused to come into contact with the housing by the spring, and
when the one end of the rotating shaft is coupled to the other rotating body, the one end of the rotating shaft is caused to be separated from the housing in resistance to the biasing force of the spring.

2. The rotating shaft support apparatus according to claim 1, wherein
a rotating shaft side contact portion that comes into contact with the housing is provided on the one end of the rotating shaft, a housing side contact portion that comes into contact with the rotating shaft side contact portion is provided on the housing, a tapered surface, a diameter of which becomes smaller toward the side of an biasing direction of the spring, is formed on at least one of the rotating shaft side contact portion and the housing side contact portion, and the axial run-out of the rotating shaft is suppressed by both of the rotating shaft side contact portion and the housing side contact portion coining into contact with each other via the tapered surface.

3. The rotating shaft support apparatus according to claim 1, wherein
the other rotating body is rotatably supported by a different housing than the housing, and the one end of the rotating shaft is axially supported by being coupled to the other rotating body when both of the housing and the different housing are fixed.

4. The rotating shaft support apparatus according to claim 2, wherein
the other rotating body is rotatably supported by a different housing than the housing, and the one end of the rotating shaft is axially supported by being coupled to the other rotating body when both of the housing and the different housing are fixed.

5. The rotating shaft support apparatus according to claim 3, wherein
the one end of the rotating shaft is rotatably supported by being inserted through a second bearing that is provided in the different housing and that rotatably supports the other rotating body.

6. The rotating shaft support apparatus according to claim 4, wherein
the one end of the rotating shaft is rotatably supported by being inserted through a second bearing that is provided in the different housing and that rotatbly supports the other rotating body.

7. The rotating shaft support apparatus according to claim 5, wherein
the rotating shaft and the other rotating body are directly coupled inside the second bearing such that rotation transmission is possible.

8. The rotating shaft support apparatus according to claim 6, wherein
the rotating shaft and the other rotating body are directly coupled inside the second bearing such that rotation transmission is possible.

9. A magnetic motor that includes the rotating shaft support apparatus according to claim 1, wherein
the magnetic motor includes an armature core that is arranged such that it encompasses the rotating shaft,
a stator, which is arranged around the periphery of the armature core, is provided on the housing, and
one of the armature core and the stator is formed of a permanent magnet.
